(19) United States
(12) Patent Application Publication
(10) Pub. No.: US 2005/0164882 A1
(43) Pub. Date: Jul. 28, 2005

(54) Method for increasing the resistance of plants to the phytotoxicity of agrochemicals

(76) Inventors: Eberhard Ammermann, Heppenheim (DE); Reinhard Stierl, Heppenheim (DE); Gisela Lorenz, Neustadt (DE); Gerd Stammler, Dossenheim (DE); Klaus Schelberger, Gonnheim (DE); James Spadafora, Sugar Land, TX (US); Cyrill Zagar, Mannheim (DE); Matthias Witschel, Bad Durkheim (DE); Akihide Watanabe, Ayase-shi (JP); Masatoshi Motoyoshi, Toyohashi-shi (JP); Kenichi Kojima, Yokohama-shi (JP)

Correspondence Address: NOVAK DRUCE DELUCA & QUIGG, LLP, 1300 EYE STREET NW, SUITE 400 EAST, WASHINGTON, DC, 20005, US

(21) Appl. No.: 10/509,635

(22) PCT Filed: Apr. 7, 2003
(86) PCT No.: PCT/EP03/03571

(30) Foreign Application Priority Data
Apr. 10, 2002 (DE) 10215815.0

(51) Int. Cl. A01N 25/32

(52) U.S. Cl. 504/105

(57) ABSTRACT

A method for increasing the resistance of plants to the phytotoxicity of agrochemicals comprises treating the plants, the soil or seeds with an effective amount of a compound of the formula I 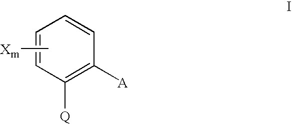 in which X is halogen, alkyl or trifluoromethyl; m is 0 or 1;
Q is C(═CH—CH₃)—COOCH₃, C(═CH—OCH₃)—COOCH₃, C(═N—OCH₃)—CONHCH₃, C(═N—OCH₃)—COOCH₃, N(—OCH₃)—COOCH₃ or a group Q1, 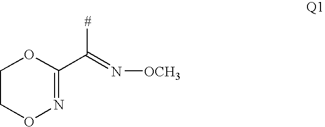 where # indicates the bond to the phenyl ring;
A is —O—B, —CH₂O—B, —OCH₂—B, —CH═CH—B, —C—C—B, —CH₂O—N═C(R¹)—B or —CH₂O—N═C(R¹)—C(R²)═N—OR³, where B is phenyl, naphthyl, 5-membered or 6-membered hetaryl or 5-membered or 6-membered heterocyclyl, the ring systems being unsubstituted or substituted as specified in the description;
   R¹ is hydrogen, cyano, alkyl, haloalkyl, cycloalkyl or alkoxy;
   R² is phenyl, phenylcarbonyl, phenylsulfonyl, 5- or 6-membered hetaryl, 5- or 6-membered hetarylcarbonyl or 5- or 6-membered hetarylsulfonyl, the ring systems being unsubstituted or substituted as specified in the description, alkyl, cycloalkyl, alkenyl, alkynyl, alkylcarbonyl, alkenylcarbonyl, alkynylcarbonyl, alkylsulfonyl or C(R′)═NOR″, the hydrocarbon radicals of these groups being unsubstituted or substituted as specified in the description;
   R³ is hydrogen, alkyl, alkenyl, alkynyl, the hydrocarbon radicals of these groups being unsubstituted or substituted as specified in the description, which is taken up by the plants or seeds.

The present invention relates to a method for increasing the resistance of plants to the phytotoxicity of agrochemicals, which comprises treating the plants, the soil or seeds with an effective amount of a compound of the formula I 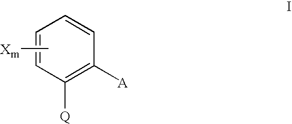
in which
X is halogen, C₁-C₄-alkyl or trifluoromethyl;
m is 0 or 1;
Q is C(═CH—CH₃)—COOCH₃, C(═CH—OCH₃)—COOCH₃, C(═N—OCH₃)—CONHCH₃, C(═N—OCH₃)—COOCH₃, N(—OCH₃)—COOCH₃ or a group Q1 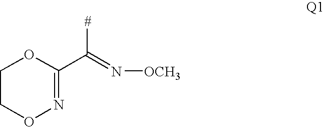
   where # indicates the bond to the phenyl ring;
A is —O—B, —CH₂O—B, —OCH₂—B, —CH═CH—B, —C≡C—B, —CH₂O—N═C(R¹)—B or —CH₂O—N═C(R¹)—C(R²)═N—OR³, where
   B is phenyl, naphthyl, 5-membered or 6-membered hetaryl or 5-membered or 6-membered heterocyclyl comprising one to three N atoms and/or one O or S atom or one or two O and/or S atoms, the ring systems being unsubstituted or substituted by one to three radicals R^{a}:
      R^{a} is cyano, nitro, amino, aminocarbonyl, aminothiocarbonyl, halogen, C₁-C₆-alkyl, C₁-C₆-haloalkyl, C₁-C₆-alkylcarbonyl, C₁-C₆-alkylsulfonyl, C₁-C₆-alkylsulfoxyl, C₃-C₆-cycloalkyl, C₁-C₆-alkoxy, C₁-C₆-haloalkoxy, C₁-C₆-alkyloxycarbonyl, C₁-C₆-alkylthio, C₁-C₆-alkylamino, di-C₁-C₆-alkylamino, C₁-C₆-alkylaminocarbonyl, di-C₁-C₆-alkylaminocarbonyl, C₁-C₆-alkylaminothiocarbonyl, di-C₁-C₆-alkylaminothiocarbonyl, C₂-C₆-alkenyl, C₂-C₆-alkenyloxy, phenyl, phenoxy, benzyl, benzyloxy, 5- or 6-membered heterocyclyl, 5- or 6-membered hetaryl, 5- or 6-membered hetaryloxy, C(═NOR′)—OR″ or OC(R′)₂—C(R″)═NOR″, the cyclic radicals, in turn, being unsubstituted or substituted by one to three radicals R^{b}:
         R^{b} is cyano, nitro, halogen, amino, aminocarbonyl, aminothiocarbonyl, C₁-C₆-alkyl, C₁-C₆-haloalkyl, C₁-C₆-alkylsulfonyl, C₁-C₆-alkylsulfoxyl, C₃-C₆-cycloalkyl, C₁-C₆-alkoxy, C₁-C₆-haloalkoxy, C₁-C₆-alkoxycarbonyl, C₁-C₆-alkylthio, C₁-C₆-alkylamino, di-C₁-C₆-alkylamino, C₁-C₆-alkylaminocarbonyl, di-C₁-C₆-alkylaminocarbonyl, C₁-C₆-alkylaminothiocarbonyl, di-C₁-C₆-alkylaminothiocarbonyl, C₂-C₆-alkenyl, C₂-C₆-alkenyloxy, C₃-C₆-cycloalkyl, C₃-C₆-cycloalkenyl, phenyl, phenoxy, phenylthio, benzyl, benzyloxy, 5- or 6-membered heterocyclyl, 5- or 6-membered hetaryl, 5- or 6-membered hetaryloxy or C(═NOR′)—OR″;
         R′ is hydrogen, cyano, C₁-C₆-alkyl, C₃-C₆-cycloalkyl or C₁-C₄-haloalkyl;
         R″ is hydrogen, C₁-C₆-alkyl, C₃-C₆-alkenyl, C₃-C₆-alkynyl, C₁-C₄-haloalkyl, C₃-C₆-haloalkenyl or C₃-C₆-haloalkynyl;
   R¹ is hydrogen, cyano, C₁-C₄-alkyl, C₁-C₄-haloalkyl, C₃-C₆-cycloalkyl, C₁-C₄-alkoxy;
   R² is phenyl, phenylcarbonyl, phenylsulfonyl, 5- or 6-membered hetaryl, 5- or 6-membered hetarylcarbonyl or 5- or 6-membered hetarylsulfonyl, the ring systems being unsubstituted or substituted by one to three radicals R^{a},
      C₁-C₁₀-alkyl, C₃-C₆-cycloalkyl, C₂-C₁₀-alkenyl, C₂-C₁₀-alkynyl, C₁-C₁₀-alkylcarbonyl, C₂-C₁₀-alkenylcarbonyl, C₃-C₁₀-alkynylcarbonyl, C₁-C₁₀-alkylsulfonyl or C(R′)═NOR″, the hydrocarbon radicals of these groups being unsubstituted or substituted by one to three radicals R_{c}:
      R^{c} is cyano, nitro, amino, aminocarbonyl, aminothiocarbonyl, halogen, C₁-C₆-alkyl, C₁-C₆-haloalkyl, C₁-C₆-alkylsulfonyl, C₁-C₆-alkylsulfoxyl, C₁-C₆-alkoxy, C₁-C₆-haloalkoxy, C₁-C₆-alkoxycarbonyl, C₁-C₆-alkylthio, C₁-C₆-alkylamino, di-C₁-C₆-alkylamino, C₁-C₆-alkylaminocarbonyl, di-C₁-C₆-alkylaminocarbonyl, C₁-C₆-alkylaminothiocarbonyl, di-C₁-C₆-alkylaminothiocarbonyl, C₂-C₆-alkenyl, C₂-C₆-alkenyloxy,
         C₃-C₆-cycloalkyl, C₃-C₆-cycloalkyloxy, 5- or 6-membered heterocyclyl, 5- or 6-membered heterocyclyloxy, benzyl, benzyloxy, phenyl, phenoxy, phenylthio, 5- or 6-membered hetaryl, 5- or 6-membered hetaryloxy and hetarylthio, it being possible for the cyclic groups, in turn, to be partially or fully halogenated or to have attached to them one to three radicals R^{a}; and
   R³ is hydrogen,
      C₁-C₆-alkyl, C₂-C₆-alkenyl, C₂-C₆-alkynyl, the hydrocarbon radicals of these groups being unsubstituted or substituted by one to three radicals R^{c};
         which is taken up by the plants or seeds.

Besides, the invention generally relates to the use of the compounds of the formula I for increasing the resistance of plants to the phytotoxicity of agrochemicals.

Agrochemicals for the purposes of the present invention include in particular fertilizers or herbicidal, growth-regulatory, fungicidal, insecticidal or nematicidal crop protection products.

The compatibility of crop plants with agrochemicals is not always entirely sufficient, i.e. not only a desired growth-promoting, herbicidal, growth-regulatory, fungicidal, insecticidal or nematicidal effect is observed, but in some cases the crop plants are damaged to an extent which is unacceptable. Another undesired side effect of herbicidal, fungicidal, insecticidal or nematicidal crop protection products can be a growth-inhibitory effect. Reducing the application rate of the agrochemical, which is generally desired, has the disadvantage that, while the crop plant remains unharmed, the desired herbicidal, fungidical, insecticidal or nematicidal action is insufficiently achieved. The symptoms of the damage range from morphological modifications via growth inhibition to death of the plants (phytotoxicity).

Controlling such symptoms of damage is extraordinarily difficult owing to the multiplicity of the causes of damage brought about by agrochemicals; preventative measures are therefore the main priority. Accordingly, increasing the resistance of plants to the phytotoxicity of agrochemicals is an important demand in agriculture.

It was an aim of the present invention to provide a method which can be used widely, which does not damage the plants and which brings about an efficaceous increase in the resistance of the plants to the phytotoxicity of agrochemicals.

Accordingly, the method defined at the outset has been found. The active ingredients of the formula I which are used are known as fungicides and in some cases also as insecticides (EP-A 178 826; EP-A 253 213; WO-A 93/15046; WO-A 95/18789; WO-A 95/21153; WO-A 95/21154; WO-A 95/24396; WO-A 96/01256; WO-A 97/15552; WO-A 97/27189). However, a potential effect of these active ingredients with regard to increasing the resistance of plants to the phytotoxicity of agrochemicals has not been mentioned as yet.

Active ingredients which reduce undesired side effects of other agrochemicals are usually termed “safeners”. The use of the active ingredients of the formula I as safeners is novel.

The good tolerance by plants of the active ingredients of the formula I at the concentrations required for controlling plant diseases permits the treatment of aerial plant parts and also the treatment of propagation material, seed and of the soil.

In the method according to the invention, the active ingredient is preferably taken up via the roots of the plants and distributed throughout the plant with the sap.

This is why the effect after using the method according to the invention is not only observed in those plant parts which were sprayed directly, but the resistance to the phytotoxicity of agrochemicals is increased throughout the plant.

In a preferred embodiment of the method, the subterranean plant parts are treated with a formulation of the active ingredient I.

In another preferred embodiment of the method, the seed is treated with a formulation of the active ingredient I.

The preparation of the active ingredients used in the method according to the invention is known from the publications cited at the outset.

Especially preferred active ingredients for the method according to the invention are those with the following meanings of the substituents, in each case alone or in combination: Especially preferred active ingredients for the method according to the invention are in particular those of the formulae II to VIII, in which
V is OCH₃ or NHCH₃ and Y is CH or N.

Preferred active ingredients of the formula I in which Q is C(═N—OCH₃)—COOCH₃ are the compounds described in the publications EP-A 253 213 and EP-A 254 426.

Preferred active ingredients of the formula I in which Q is C(═N—OCH₃)—CONHCH₃ are the compounds described in the publications EP-A 398 692, EP-A 477 631 and EP-A 628 540.

Preferred active ingredients of the formula I in which Q is N(—OCH₃)—COOCH₃ are the compounds described in the publications WO-A 93/15046 and WO-A 96/01256.

Preferred active ingredients of the formula I in which Q is C(═CH—OCH₃)—COOCH₃ are the compounds described in the publications EP-A 178 826 and EP-A 278 595.

Preferred active ingredients of the formula I in which Q is C(═CH—CH₃)—COOCH₃ are the compounds described in the publications EP-A 280 185 and EP-A 350 691.

Preferred active ingredients of the formula I in which Q is a group Q1 are the compounds described in WO-A 97/27189.

Preferred active ingredients of the formula I in which A is —CH₂O—N═C(R¹)—B are the compounds described in the publications EP-A 460 575 and EP-A 463 488.

Preferred active ingredients of the formula I in which A is —O—B are the compounds described in the publications EP-A 382 375 and EP-A 398 692.

Preferred active ingredients of the formula I in which A is —CH₂O—N═C(R¹)—C(R²)═N—OR³ are the compounds described in the publications WO-A 95/18789, WO-A 95/21153, WO-A 95/21154, WO-A 97/05103, WO-A 97/06133 and WO-A 97/15552.

Especially preferred active ingredients of the formula I are those in which
Q is C(═N—OCH₃)—COOCH₃ or C(═N—OCH₃)—CONHCH₃;
A is CH₂—O— and
B is —N═C(R¹)—C(R²)═N—OR³, where
R¹ is hydrogen, cyano, cyclopropyl, C₁-C₄-alkyl or C₁-C₂-haloalkyl, in particular methyl, ethyl, 1-methylethyl or trifluoromethyl, and
R² is C₁-C₄-alkyl, C₂-C₅-alkenyl, phenyl which is substituted by one or two halogen atoms, or is C(R′)═NOR″, where R′ is one of the groups mentioned above under R¹ and R″ is hydrogen, cyclopropyl, C₁-C₄-alkyl, in particular methyl, ethyl or iso-propyl, and
R³ is one of the groups mentioned under R″;
   these active ingredients are described by the formula II 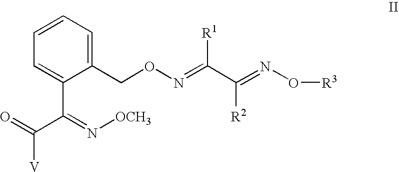
   in which the variables have the abovementioned meanings.

Particularly preferred active ingredients are those of the formula IIA 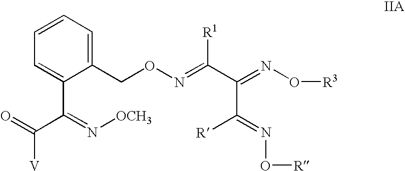
in which the variables have the abovementioned meanings.

Other compounds of the formula III which are especially preferred are, in addition, those in which T is CH or N and R^{a}′ and R^{b} are halogen or C₁-C₄-alkyl and x is 0, 1 or 2 and y is 0 or 1.

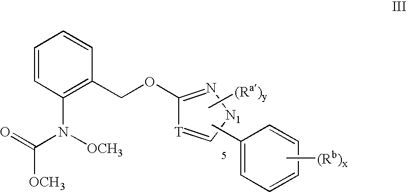

With regard to their use as safeners, the active ingredients compiled in the tables which follow are especially preferred.

TABLE I

| | |
|---|---|
| | II |
| 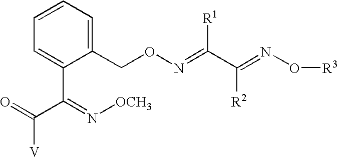 | |

| No. | V | R¹ | R² | R³ | Reference |
|---|---|---|---|---|---|
| I-1 | OCH₃ | CH₃ | CH₃ | CH₃ | WO-A 95/18789 |
| I-2 | OCH₃ | CH₃ | CH(CH₃)₂ | CH₃ | WO-A 95/18789 |
| I-3 | OCH₃ | CH₃ | CH₂CH₃ | CH₃ | WO-A 95/18789 |
| I-4 | NHCH₃ | CH₃ | CH₃ | CH₃ | WO-A 95/18789 |
| I-5 | NHCH₃ | CH₃ | 4-F-C₆H₄ | CH₃ | WO-A 95/18789 |
| I-6 | NHCH₃ | CH₃ | 4-Cl-C₆H₄ | CH₃ | WO-A 95/18789 |
| I-7 | NHCH₃ | CH₃ | 2,4-C₆H₃ | CH₃ | WO-A 95/18789 |
| I-8 | NHCH₃ | Cl | 4-F-C₆H₄ | CH₃ | WO-A 98/38857 |
| I-9 | NHCH₃ | Cl | 4-Cl-C₆H₄ | CH₂CH₃ | WO-A 98/38857 |
| I-10 | NHCH₃ | CH₃ | CH₂C(═CH₂)CH₃ | CH₃ | WO-A 97/05103 |
| I-11 | NHCH₃ | CH₃ | CH═C(CH₃)₂ | CH₃ | WO-A 97/05103 |
| I-12 | NHCH₃ | CH₃ | CH═C(CH₃)₂ | CH₂CH₃ | WO-A 97/05103 |
| I-13 | NHCH₃ | CH₃ | CH═C(CH₃)CH₂CH₃ | CH₃ | WO-A 97/05103 |
| I-14 | NHCH₃ | CH₃ | O—CH(CH₃)₂ | CH₃ | WO-A 97/06133 |
| I-15 | NHCH₃ | CH₃ | O—CH₂CH(CH₃)₂ | CH₃ | WO-A 97/06133 |
| I-16 | NHCH₃ | CH₃ | C(CH₃)═NOCH₃ | CH₃ | WO-A 97/15552 |
| I-17 | NHCH₃ | CH₃ | C(CH₃)═NOCH₂CH₃ | CH₂CH₃ | WO-A 97/15552 |
| I-18 | NHCH₃ | CH₃ | C(CH₃)═NOCH(CH₃)₂ | CH(CH₃)₂ | WO-A 97/15552 |
| I-19 | NHCH₃ | CH₃ | C(CH₃)—NO(c-C₃H₅) | c-C₃H₅ | WO-A 97/15552 |
| I-20 | NHCH₃ | CH₃ | C(CH₃)═NOCH₂CH═CH₂ | CH₂CH═CH₂ | WO-A 97/15552 |
| I-21 | NHCH₃ | CF₃ | C(CF₃)═NOCH₃ | CH₃ | WO-A 97/15552 |
| I-22 | NHCH₃ | CF₃ | C(CF₃)═NOCH₂CH₃ | CH₂CH₃ | WO-A 97/15552 |
| I-23 | NHCH₃ | CF₃ | C(CF₃)═NOCH(CH₃)₂ | CH(CH₃)₂ | WO-A97/15552 |
| I-24 | NHCH₃ | CF₃ | C(CF₃)—NO(c-C₃H₅) | c-C₃H₅ | WO-A97/15552 |
| I-25 | NHCH₃ | CF₃ | C(CF₃)═NOCH₂CH═CH₂ | CH₂CH═CH₂ | WO-A97/15552 |
| I-26 | OCH₃ | CH₃ | C(CH₃)═NOCH₃ | CH₃ | WO-A97/15552 |
| I-27 | OCH₃ | CH₃ | C(CH₃)═NOCH₂CH₃ | CH₂CH₃ | WO-A97/15552 |
| I-28 | OCH₃ | CH₃ | C(CH₃)═NOCH(CH₃)₂ | CH(CH₃)₂ | WO-A97/15552 |
| I-29 | OCH₃ | CH₃ | C(CH₃)—NO(c-C₃H₅) | c-C₃H₅ | WO-A97/15552 |
| I-30 | OCH₃ | CH₃ | C(CH₃)═NOCH₂CH═CH₂ | CH₂CH═CH₂ | WO-A97/15552 |
| I-31 | OCH₃ | CF₃ | C(CF₃)═NOCH₃ | CH₃ | WO-A97/15552 |
| I-32 | OCH₃ | CF₃ | C(CF₃)═NOCH₂CH₃ | CH₂CH₃ | WO-A97/15552 |
| I-33 | OCH₃ | CF₃ | C(CF₃)═NOCH(CH₃)₂ | CH(CH₃)₂ | WO-A97/15552 |
| I-34 | OCH₃ | CF₃ | C(CF₃)═NO(c-C₃H₅) | c-C₃H₅ | WO-A97/15552 |
| I-35 | OCH₃ | CF₃ | C(CF₃)═NOCH₂CH═CH₂ | CH₂CH═CH₂ | WO-A97/15552 |

TABLE II

| | |
|---|---|
| | III |
| 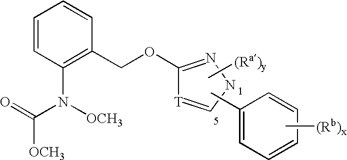 | |

| | | | Position of the | | |
|---|---|---|---|---|---|
| No. | T | (R^{a′})_{y} | phenyl-(R^{b})ₓ group | (R^{b})ₓ | Reference |
| II-1 | N | — | 1 | 2,4-Cl₂ | WO-A 96/01256 |
| II-2 | N | — | 1 | 4-Cl | WO-A 96/01256 |
| II-3 | CH | — | 1 | 2-Cl | WO-A 96/01256 |
| II-4 | CH | — | 1 | 3-Cl | WO-A 96/01256 |
| II-5 | CH | — | 1 | 4-Cl | WO-A 96/01256 |
| II-6 | CH | — | 1 | 4-CH₃ | WO-A 96/01256 |
| II-7 | CH | — | 1 | H | WO-A 96/01256 |
| II-8 | CH | — | 1 | 3-CH₃ | WO-A 96/01256 |
| II-9 | CH | 5-CH₃ | 1 | 3-CF₃ | WO-A 96/01256 |
| II-10 | CH | 1-CH₃ | 5 | 3-CF₃ | WO-A 99/33812 |
| II-11 | CH | 1-CH₃ | 5 | 4-Cl | WO-A 99/33812 |
| II-12 | CH | 1-CH₃ | 5 | — | WO-A 99/33812 |

TABLE III

| | |
|---|---|
| | IV |
| 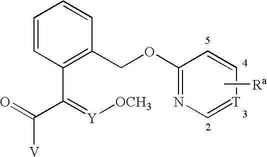 | |

| No. | V | Y | T | R^{a} | Reference |
|---|---|---|---|---|---|
| III-1 | OCH₃ | CH | N | 2-OCH₃, 4-CF₃ | WO-A 96/16047 |
| III-2 | OCH₃ | CH | N | 2-OCH(CH₃)₂, 4-CF₃ | WO-A 96/16047 |
| III-3 | OCH₃ | CH | CH | 2-CF₃ | EP-A 278 595 |
| III-4 | OCH₃ | CH | CH | 3-CF₃ | EP-A 278 595 |
| III-5 | NHCH₃ | N | CH | 3-Cl | EP-A 398 692 |
| III-6 | NHCH₃ | N | CH | 3-CF₃ | EP-A 398 692 |
| III-7 | NHCH₃ | N | CH | 3-CF₃, 5-Cl | EP-A 398 692 |
| III-8 | NHCH₃ | N | CH | 3-Cl, 5-CF₃ | EP-A 398 692 |

TABLE IV

| | |
|---|---|
| | V |
| 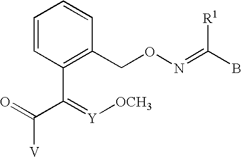 | |

| No. | V | Y | R¹ | B | Reference |
|---|---|---|---|---|---|
| IV-1 | OCH₃ | CH | CH₃ | (3-CF₃)C₆H₄ | EP-A 370 629 |
| IV-2 | OCH₃ | CH | CH₃ | (3,5-Cl₂)C₆H₃ | EP-A 370 629 |
| IV-3 | NHCH₃ | N | CH₃ | (3-CF₃)C₆H₄ | WO-A 92/13830 |
| IV-4 | NHCH₃ | N | CH₃ | (3-OCF₃)C₆H₄ | WO-A 92/13830 |
| IV-5 | OCH₃ | N | CH₃ | (3-OCF₃)C₆H₄ | EP-A 460 575 |
| IV-6 | OCH₃ | N | CH₃ | (3-CF₃)C₆H₄ | EP-A 460 575 |
| IV-7 | OCH₃ | N | CH₃ | (3,4-Cl₂)C₆H₃ | EP-A 460 575 |
| IV-8 | OCH₃ | N | CH₃ | (3,5-Cl₂)C₆H₃ | EP-A 463 488 |

TABLE V

| | |
|---|---|
| | VI |
| 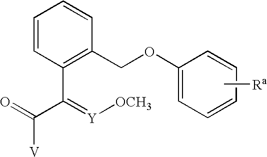 | |

| No. | V | Y | R^{a} | Reference |
|---|---|---|---|---|
| V-1 | OCH₃ | N | 2-CH₃ | EP-A 253 213 |
| V-2 | OCH₃ | N | 2,5-(CH₃)₂ | EP-A 253 213 |
| V-3 | NHCH₃ | N | 2,5-(CH₃)₂ | EP-A 477 631 |
| V-4 | NHCH₃ | N | 2-Cl | EP-A 477 631 |
| V-5 | NHCH₃ | N | 2-CH₃ | EP-A 477 631 |
| V-6 | NHCH₃ | N | 2-CH₃, 4-OCF₃ | EP-A 628 540 |
| V-7 | NHCH₃ | N | 2-Cl, 4-OCF₃ | EP-A 628 540 |
| V-8 | NHCH₃ | N | 2-CH₃, 4- | EP-A 11 18 609 |
| | | | OCH(CH₃)—C(CH₃)═NOCH₃ | |
| V-9 | NHCH₃ | N | 2-Cl, 4- | EP-A 11 18 609 |
| | | | OCH(CH₃)—C(CH₃)═NOCH₃ | |
| V-10 | NHCH₃ | N | 2-CH_{3, 4-OCH(CH}₃)— | EP-A 11 18 609 |
| | | | C(CH₂CH₃)═NOCH₃ | |
| V-11 | NHCH₃ | N | 2-Cl, 4-OCH(CH₃)— | EP-A 11 18 609 |
| | | | C(CH₃)═NOCH₂CH₃ | |

TABLE VI

| | |
|---|---|
| | VII |
| 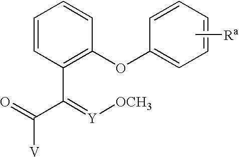 | |

| | | | | |
|---|---|---|---|---|
| No. | V | Y | R^{a} | Reference |
| VI-1 | NHCH₃ | N | H | EP-A 398 692 |
| VI-2 | NHCH₃ | N | 3-CH₃ | EP-A 398 692 |
| VI-3 | NHCH₃ | N | 2-NO₂ | EP-A 398 692 |
| VI-4 | NHCH₃ | N | 4-NO₂ | EP-A 398 692 |
| VI-5 | NHCH₃ | N | 4-Cl | EP-A 398 692 |
| VI-6 | NHCH₃ | N | 4-Br | EP-A 398 692 |

TABLE VII

| | |
|---|---|
| | VIII |
| 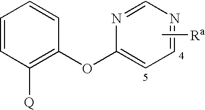 | |

| Nr. | Q | R^{a} | Reference |
|---|---|---|---|
| VII-1 | C(═CH—OCH₃)COOCH₃ | 4-O-(2-CN—C₆H₄) | EP-A 382 375 |
| VII-2 | C(═CH—OCH₃)COOCH₃ | 4-O-(2-Cl—C₆H₄) | EP-A 382 375 |
| VII-3 | C(═CH—OCH₃)COOCH₃ | 4-O-(2-CH₃—C₆H₄) | EP-A 382 375 |
| VII-4 | C(═N-OCH₃)CONHCH₃ | 4-O-(2-Cl—C₆H₄) | GB-A 2253624 |
| VII-5 | C(═N-OCH₃)CONHCH₃ | 4-O-(2,4-Cl₂—C₆H₃) | GB-A 2253624 |
| VII-6 | C(═N-OCH₃)CONHCH₃ | 4-O-(2-CH₃—C₆H₄) | GB-A 2253624 |
| VII-7 | C(═N-OCH₃)CONHCH₃ | 4-O-(2-CH₃,3-Cl—C₆H₃) | GB-A 2253624 |
| VII-8 | C(═N-OCH₃)CONHCH₃ | 4-O-(2-CH₃—C₆H₄),5-F | WO-A 98/21189 |
| VII-9 | C(═N-OCH₃)CONHCH₃ | 4-O-(2-Cl—C₆H₄),5-F | WO-A 98/21189 |
| VII-10 | C(═N-OCH₃)CONHCH₃ | 4-O-(2-CH₃,3-Cl—C₆H₃),5-F | WO-A 98/21189 |
| VII-11 | C(═N-OCH₃)CONHCH₃ | 4-O-(2-Cl,3-CH₃—C₆H₃),5-F | WO-A 98/21189 |
| VII-12 | Q1 | 4-O-(2-Cl—C₆H₄),5-F | WO-A 97/27189 |
| VII-13 | Q1 | 4-O-(2-CH₃,3-Cl—C₆H₃),5-F | WO-A 97/27189 |
| VII-14 | Q1 | 4-O-(2-Cl,3-CH₃—C₆H₃),5-F | WO-A 97/27189 |

The compounds I increase the resistance of the plant to the phytotoxicity of agrochemicals. They are especially important for the treatment of various crop plants such as wheat, barley, rye, oats, rice, golf turf, maize, bananas, cotton, soya, coffee, grapevines, fruit species and ornamentals, and vegetable species such as cucumbers, beans, tomatoes, potatoes and the pumpkin family, and on the seeds of these plants, in particular wheat, barley, rye, oats, maize and rice.

Specifically, they are suitable for controlling the following symptoms of damage:
reduced plant height in rice, cereals or tomatoes,
development of necroses in dicotyledonous crops such as cucumbers or grapevines,
deformation of the leaves in wheat, cucumbers or tomatoes,
discoloration of the green leaf tissue, such as, for example, bleaching in barley or soya,
wilting symptoms despite adequate nutrient supply.

The compounds I are applied by treating the plants to be protected, seeds or the soil with an effective amount of the active ingredients. Application can be effected both before and after application of the phytotoxic agrochemical to the plants or seeds.

In a preferred embodiment of the method, the plant is treated concomitantly with the application of the other (phytotoxic) agrochemical. A markedly reduced susceptibility of the plant to the phytotoxicity of the other agrochemical is observed.

Agrochemicals are understood as meaning essentially the herbicidal, acaricidal, insecticidal, nematicidal and fungicidal substances listed on the Internet under http://www.hclrss.demon.co.uk/index_cn_frame.html (index of common names). In particular, the active ingredients of the formula I are applied together with herbicidal, acaricidal, insecticidal, nematicidal or fungicidal agrochemicals selected from the list which follows:

abamectin; acephate; acequinocyl; acetamiprid; acethion; acetochlor; acetoprole; acifluorfen; aclonifen; ACN; acrinathrin; acrolein; acrylonitrile; acypetacs; alachlor; alanap; alanycarb; aldicarb; aldimorph; aldoxycarb; aldrin; allethrin; d-trans-allethrin; allidochlor; allosamidin; alloxydim; allyl alcohol; allyxycarb; alorac; alpha-cypermethrin; ametridione; ametryn; ametryne; amibuzin; amicarbazone; amidithion; amidoflumet; amidosulfuron; aminocarb; aminotriazole; amiprofos-methyl; amiton; amitraz; amitrole; ammonium sulfamate; ampropylfos; AMS; anabasine; anilazine; anilofos; anisuron; arprocarb; arsenous oxide; asulam; athidathion; atraton; atrazine; aureofungin; avermectin B1; azaconazole; azadirachtin; azafenidin; azamethiphos; azidithion; azimsulfuron; azinphos-ethyl (=azinphosethyl); azinphos-methyl (=azinphosmethyl); aziprotryn (=aziprotryne); azithiram; azobenzene; azocyclotin; azothoate; barban (=barbanate); barium hexafluorosilicate; barium polysulfide; barium silicofluoride; barthrin; BCPC; beflubutamid; benalaxyl; benazolin; bendiocarb; bendioxide; benefin (=benfluralin); benfuracarb; benfuresate; benodanil; benomyl; benoxafos; benquinox; bensulfuron; bensulide; bensultap; bentaluron; bentazon (=bentazone); benthiocarb; benzadox; benzalkonium chloride; benzamacril; benzamizole; benzamorf; benzene hexachloride; benzfendizone; benzipram; benzobicyclon; benzoepin; benzofenap; benzofluor; benzohydroxamic acid; benzomate benzoximate (=benzoylprop); benzthiazuron; benzyl benzoate; beta-cyfluthrin; beta-cypermethrin; bethoxazin; BHC; gamma-BHC; bialaphos; bifenazate; bifenox; bifenthrin; bilanafos; binapacryl; bioallethrin; bioethanomethrin; biopermethrin; bioresmethrin; biphenyl; bispyribac; bistrifluron; bitertanol; bithionol; blasticidin-S; borax; Bordeaux mixture; BPPS; bromacil; bromchlophos; bromfenvinfos; bromobonil; bromobutide; bromocyclen; bromo-DDT; bromofenoxim; bromomethane; bromophos; bromophos-ethyl; bromopropylate; bromoxynil; brompyrazon; bromuconazole; BRP; bufencarb; bupirimate; buprofezin; Burgundy mixture; butacarb; butachlor; butafenacil; butam; butamifos; butathiofos; butenachlor; buthidazole; buthiobate; buthiuron; butocarboxim; butonate; butoxycarboxim; butralin; butroxydim; buturon; butylamine; butylate; butylchlorophos; cacodylic acid; cadusafos; cafenstrole; calcium arsenate; calcium chlorate; calcium cyanamide; calcium polysulfide; cambendichlor; camphechlor; captafol; captan; carbam; carbamorph; carbanolate; carbaryl; carbasulam; carbathion; carbendazim; carbetamide; carbofuran; carbon disulfide; carbon tetrachloride; carbophenothion; carbophos; carbosulfan; carboxazole; carboxin; carfentrazone; carpropamid; cartap; carvone; CDAA; CDEA; CDEC; CEPC; cerenox; cevadilla; Cheshunt mixture; chinalphos; chinalphos-methyl; chinomethionat; chlobenthiazone; chlomethoxyfen; chlor-IPC; chloramben; chloraniformethan; chloranil; chloranocryl; chlorazifop; chlorazine; chlorbenside; chlorbicyclen; chlorbromuron; chlorbufam; chlordane; chlordecone; chlordimeform; chlorethoxyfos; chloreturon; chlorfenac; chlorfenapyr; chlorfenazole; chlorfenethol; chlorfenidim; chlorfenizon; chlorfenprop; chlorfenson; chlorfensulphide; chlorfenvinphos; chlorfenvinphos-methyl; chlorfluazuron; chlorflurazole; chlorflurecol; chlorflurenol; chloridazon; chlorimuron; chlorinate; chlormephos; chlormethoxynil; chlornitrofen; chloroacetic acid; chlorobenzilate; chloroform; chloromebuform; chloromethiuron; chloroneb; chlorophos; chloropicrin; chloropon; chloropropylate; chlorothalonil; chlorotoluron; chloroxifenidim (=chloroxuron); chloroxynil; chlorphoxim; chlorprazophos; chlorprocarb; chlorpropham; chlorpyrifos; chlorpyrifos-methyl; chlorquinox; chlorsulfuron; chlorthal; chlorthiamid; chlorthiophos; chlortoluron; chlozolinate; chromafenozide; cinidon-ethyl; cinerin I; cinerin II; cinmethylin; cinosulfuron; cisanilide; cismethrin; clethodim; climbazole; cliodinate; clodinafop; cloethocarb; clofentezine; clofop; clomazone; clomeprop; cloprop; cloproxydim; clopyralid; cloransulam; closantel; clothianidin; clotrimazole; CMA; CMMP; CMP; CMU; copper acetate; copper acetoarsenite; copper arsenate; copper carbonate, basic; copper hydroxide; copper naphthenate; copper oleate; copper oxychloride; copper 8-quinolinolate; copper silicate; copper sulfate; copper sulfate, basic; copper zinc chromate; coumaphos; coumithoate; 4-CPA; 4-CPB; CPMF; 4-CPP; CPPC; cresol (=cresylic acid); crotamiton; crotoxyfos (=crotoxyphos); crufomate; cryolite; cufraneb; cumyluron; cuprobam; cuprous oxide; CVMP; cyanatryn; cyanazine; cyanofenphos; cyanophos; cyanthoate; cyazofamid; cyclafuramid; cyclethrin; cycloate; cycloheximide; cycloprothrin; cyclosulfamuron; cycloxydim; cyflufenamid; cycluron; cyfluthrin; beta-cyfluthrin; cyhalofop; cyhalothrin; gamma-cyhalothrin; lambda-cyhalothrin; cyhexatin; cymoxanil; cypendazole; cypermethrin; alpha-cypermethrin; beta-cypermethrin; theta-cypermethrin; zeta-cypermethrin; cyperquat; cyphenothrin; cyprazine; cyprazole; cyprex; cyproconazole; cyprodinil; cyprofuram; cypromid; cyromazine; cythioate; 2,4-D; 3,4-DA; daimuron; dalapon; dazomet; 2,4-DB; 3,4-DB; DBCP; DCB; DCIP; DCPA (USA); DCPA (Japan); DCU; DDD; DDPP; DDT; pp (pure)-DDT; DDVP; 2,4-DEB; debacarb; decafentin; decarbofuran; dehydroacetic acid; deiquat; delachlor; delnav; deltamethrin; demephion; demephion-O; demephion-S; demeton; demeton-methyl; demeton-O; demeton-O-methyl; demeton-S; demeton-S-methyl; demeton-S-methylsulphon (=demeton-S-methyl sulphone); DEP; 2,4-DEP; depalléthrine; derris; 2,4-DES; desmedipham; desmetryn (=desmetryne); diafenthiuron; dialifor (=dialifos); di-allate (=diallate); diamidafos; dianat; diazinon; dibrom; 1,2-dibromoethane; dicamba; dicapthon; dichlobenil; dichlofenthion; dichlofluanid; dichlone; dichloralurea; dichlorfenidim; dichlormate; o-dichlorobenzene (=ortho-dichlorobenzene); p-dichlorobenzene (=para-dichlorobenzene); 1,2-dichloroethane; dichloromethane; dichlorophen; 1,2-dichloropropane; 1,3-dichloropropene; dichlorprop; dichlorprop-P; dichlorvos; dichlozoline; diclobutrazol; diclocymet; diclofop; diclomezine; dicloran; diclosulam; dicofol; dicresyl; dicrotophos; dicryl; dicyclanil; dieldrin; dienochlor; diethamquat; diethatyl; diethion (=diéthion); diethofencarb; diethyl pyrocarbonate; difenoconazole; difenopenten; difenoxuron; difenzoquat; diflubenzuron; diflufenican (=diflufenicanil); diflufenzopyr; diflumetorim; dilor; dimefox; dimefuron; dimehypo; dimepiperate; dimetan; dimethachlor; dimethametryn; dimethenamid; dimethenamid-P; dimethirimol; dimethoate; dimethomorph; dimethrin; dimethylvinphos; dimetilan; dimexano; dimidazon; dimpylate; dinex; diniconazole; diniconazole-M; dinitramine; dinobuton; dinocap; dinocap-4; dinocap-6; dinocton; dinofenate; dinopenton; dinoprop; dinosam; dinoseb; dinosulfon; dinotefuran; dinoterb; dinoterbon; diofenolan; dioxabenzofos; dioxacarb; dioxathion; diphenamid; diphenyl sulfone; diphenylamine; diphenylsulphide; dipropetryn; dipterex; dipyrithione; diquat; disugran; disul; disulfiram; disulfoton; ditalimfos; dithianon; dithicrofos; dithiométon; dithiopyr; diuron; dixanthogen; DMPA; DNOC; dodemorph; dodicin; dodine; dofenapyn; doguadine; doramectin (=2,4-DP); 3,4-DP; DPC; drazoxolon; DSMA; d-trans-allethrin; dymron; EBEP; α-ecdysone (=α-ecdysone; ecdysterone); echlomezol; EDB; EDC; EDDP (=edifenphos); eglinazine; emamectin; EMPC; empenthrin; endosulfan; endothal (=endothall); endothion; endrin; ephirsulfonate; EPN; epofenonane; epoxiconazole; eprinomectin; epronaz; EPTC; erbon; esfenvalerate; ESP; esprocarb; etaconazole; etaphos; etem; ethaboxam; ethalfluralin; ethametsulfuron; ethidimuron; ethiofencarb; ethiolate; ethion; ethiprole; ethirimol; ethoate-methyl; ethofumesate; ethoprop (=ethoprophos); ethoxyfen; ethoxyquin; ethoxysulfuron; ethyl pyrophosphate; ethylan (=ethyl-DDD); ethylene dibromide; ethylene dichloride; ethylene oxide; ethyl formate; ethylmercury acetate; ethylmercury bromide; ethylmercury chloride; ethylmercury phosphate; etinofen; ETM; etnipromid; etobenzanid; etofenprox; etoxazole; etridiazole; etrimfos; EXD; famoxadone; famphur; fenac; fenamidone; fenaminosulf; fenamiphos; fenapanil; fenarimol; fenasulam; fenazaflor; fenazaquin; fenbuconazole; fenbutatin oxide; fenchlorphos; fenethacarb; fenfluthrin; fenfuram; fenhexamid; fenidin; fenitropan; fenitrothion; fénizon; fenobucarb; fenolovo; fenoprop; fenothiocarb; fenoxacrim; fenoxanil; fenoxaprop; fenoxaprop-P; fenoxycarb; fenpiclonil; fenpirithrin; fenpropathrin; fenpropidin; fenpropimorph; fenpyroximate; fenridazon; fenson; fensulfothion; fenteracol; fenthiaprop; fenthion; fenthion-ethyl; fentiaprop; fentin; fentrazamide; fentrifanil; fenuron; fenvalerate; ferbam; ferimzone; ferrous sulfate; fipronil; flamprop; flamprop-M; flazasulfuron; flonicamid; florasulam; fluacrypyrim; fluazifop; fluazifop-P; fluazinam; fluazolate; fluazuron; flubenzimine; flucarbazone; fluchloralin; flucofuron; flucycloxuron; flucythrinate; fludioxonil; fluenetil; flufenacet; flufenerim; flufenican; flufenoxuron; flufenprox; flufenpyr; flumethrin; flumetover; flumetsulam; flumezin; flumiclorac; flumioxazin; flumipropyn; fluometuron; fluorbenside; fluoridamid; fluorochloridone; fluorodifen; fluoroglycofen; fluoroimide; fluoromidine; fluoronitrofen; fluothiuron; fluotrimazole; flupoxam; flupropacil; flupropanate; flupyrsulfuron; fluquinconazole; fluridone; flurochloridone; fluromidine; fluroxypyr; flurtamone; flusilazole; flusulfamide; fluthiacet; flutolanil; flutriafol; fluvalinate; tau-fluvalinate; folpel (=folpet); fomesafen; fonofos; foramsulfuron; formaldehyde; formetanate; formothion; formparanate; fosamine; fosetyl; fosmethilan; fospirate; fosthiazate; fosthietan; fthalide; fuberidazole; furalaxyl; furametpyr; furathiocarb; furcarbanil; furconazole; furconazole-cis; furethrin; furmecyclox; furophanate; furyloxyfen; gamma-BHC; gamma-cyhalothrin; gamma-HCH; glufosinate; glyodin; glyphosate; griseofulvin; guanoctine (=guazatine); halacrinate; halfenprox; halofenozide; halosafen; halosulfuron; haloxydine; haloxyfop; HCA; HCH; gamma-HCH; HEOD; heptachlor; heptenophos; heterophos; hexachlor (=hexachloran); hexachloroacetone; hexachlorobenzene; hexachlorobutadiene; hexaconazole; hexaflumuron; hexafluoramin; hexaflurate; hexazinone; hexylthiofos; hexythiazox; HHDN; hydramethylnon; hydrogen; cyanide; hydroprene; hydroxyisoxazole; 8-hydroxyquinoline; sulfate; hymexazol; hyquincarb; IBP; imazalil; imazamethabenz; imazamox; imazapic; imazapyr; imazaquin; imazethapyr; imazosulfuron; imibenconazole; imidacloprid; iminoctadine; imiprothrin; indanofan; indoxacarb; iodobonil; iodofenphos; iodosulfuron; ioxynil; ipazine; IPC; ipconazole; iprobenfos; iprodione; iprovalicarb; iprymidam; IPSP; IPX; isamidofos; isazofos; isobenzan; isocarbamid; isocil; isodrin; isofenphos; isomethiozin; isonoruron; isopolinate; isoprocarb; isoprocil; isopropalin; isoprothiolane; isoproturon; isothioate; isouron; isovaledione; isoxaben; isoxachlortole; isoxaflutole; isoxapyrifop; isoxathion; isuron; ivermectin; jasmolin I; jasmolin II; jodfenphos; juvenile; hormone I; juvenile; hormone II; juvenile; hormone III; karbutilate; kasugamycin; kelevan; kinoprene; lactofen; lambda-cyhalothrin; lead arsenate; lenacil; leptophos; lime sulfur; d-limonene; lindane; linuron; lirimfos; lufenuron; lythidathion; M-74; M-81; MAA; malathion; maldison; malonoben; MAMA; mancopper; mancozeb; maneb; mazidox; MCC; MCPA; MCPA-thioethyl; MCPB; 2,4-MCPB; mebenil; mecarbam; mecarbinzid; mecarphon; mecoprop; mecoprop-P; medinoterb; mefenacet; mefluidide; menazon; MEP; mepanipyrim; mephosfolan; mepronil; mercaptodimethur; mercaptophos; mercaptophos-teolovy; mercaptothion; mercuric; chloride; mercuric oxide; mercurous; chloride; mesoprazine; mesosulfuron; mesotrione; mesulfen; mesulfenfos; mesulphen; metalaxyl; metalaxyl-M; metam; metamitron; metaphos; metaxon; metazachlor; metazoxolon; metconazole; metflurazon; methabenzthiazuron; methacrifos; methalpropalin; metham; methamidophos; methasulfocarb; methazole; methfuroxam; methibenzuron; methidathion; methiobencarb; methiocarb; methiuron; methocrotophos; métholcarb; methometon; methomyl; methoprene; methoprotryn; methoprotryne; methoxychlor; 2-methoxyethylmercury; chloride; methoxyfenozide; methyl bromide; methylchloroform; methyldithiocarbamic; acid; methyldymron; methylene; chloride; methyl; isothiocyanate; methyl-mercaptophos methylmercaptophos; oxide; methylmercaptophos-teolovy; methylmercury; benzoate; methylmercury; dicyandiamide; methyl parathion; methyltriazothion; metiram; metobenzuron; metobromuron; metolachlor; S-metolachlor; metolcarb; metosulam; metoxadiazone; metoxuron; metrafenone; metribuzin; metriphonate; metsulfovax; metsulfuron; mevinphos; mexacarbate; milbemectin; milneb; mipafox; MIPC; mirex; MNAF; molinate; monalide; monisouron; monochloroacetic; acid; monocrotophos; monolinuron; monosulfiram; monuron; morfamquat; morphothion; MPMC; MSMA; MTMC; myclobutanil; myclozolin; nabam; naftalofos; naled; naphthalene; naphthalic; anhydride; naphthalophos; naproanilide; napropamide; naptalam; natamycin; neburea; neburon; nendrin; nichlorfos; niclofen; niclosamide; nicobifen; nicosulfuron; nicotine; nifluridide; nikkomycins; NIP; nipyraclofen; nitenpyram; nithiazine; nitralin; nitrapyrin; nitrilacarb; nitrofen; nitrofluorfen; nitrostyrene; nitrothal-isopropyl; nobormide; norbormide; norea; norflurazon; noruron; novaluron; noviflumuron; NPA; nuarimol; OCH; octhilinone; o-dichlorobenzene; ofurace; omethoate; orbencarb; orthobencarb; ortho-dichlorobenzene; oryzalin; ovatron; ovex; oxadiargyl; oxadiazon; oxadixyl; oxamyl; oxapyrazon; oxasulfuron; oxaziclomefone; oxine-copper; oxine-Cu; oxpoconazole; oxycarboxin; oxydemeton-methyl; oxydeprofos; oxydisulfoton; oxyfluorfen; oxythioquinox; PAC; pallethrine; PAP; para-dichlorobenzene; parafluron; paraquat; parathion; parathion-methyl; Paris green; PCNB; PCP; p-dichlorobenzene; pebulate; pédinex; pefurazoate; penconazole; pencycuron; pendimethalin; penfluron; penoxsulam; pentachlorophenol; pentanochlor; pentoxazone; perfluidone; permethrin; pethoxamid; PHC; phénétacarbe; phenisopham; phenkapton; phenmedipham; phenmedipham-ethyl; phenobenzuron; phenothiol; phenothrin; phenthoate; phenylmercuriurea; phenylmercury acetate; phenylmercury chloride; phenylmercury nitrate; phenylmercury salicylate; 2-phenylphenol; phorate; phosalone; phosdiphen; phosfolan; phosmet; phosnichlor; phosphamide; phosphamidon; phosphine; phosphocarb; phoxim; phoxim-methyl; phthalide; phthalophos; phthalthrin; picloram; picolinafen; piperophos; pirimetaphos; pirimicarb; pirimiphos-ethyl; pirimiphos-methyl; PMA; PMP; polycarbamate; polychlorcamphene; polyethoxyquinoline; polyoxins; polyoxorim; potassium arsenite; potassium cyanate; potassium polysulfide; potassium thiocyanate; pp′-DDT (pure); prallethrin; precocene I; precocene II; precocene III; pretilachlor; primidophos; primisulfuron; probenazole; prochloraz; proclonol; procyazine; procymidone; prodiamine; profenofos; profluazol; profluralin; profoxydim; proglinazine; promacyl; promecarb; prometon; prometryn; prometryne; pronamide; propachlor; propafos; propamocarb; propanil; propaphos; propaquizafop; propargite; propazine; propetamphos; propham; propiconazole; propineb; propisochlor; propoxur; propoxycarbazone; propyzamide; prosulfalin; prosulfocarb; prosulfuron; prothidathion; prothiocarb; prothiofos; prothoate; protrifenbute; proxan; prymidophos; prynachlor; pydanon; pyracarbolid; pyraclofos; pyraclonil; pyraflufen; pyrazolate; pyrazolynate; pyrazon; pyrazophos; pyrazosulfuron; pyrazoxyfen; pyresmethrin; pyrethrin I; pyrethrin II; pyrethrins; pyribenzoxim; pyributicarb; pyriclor; pyridaben; pyridafol; pyridaphenthion; pyridate; pyridinitril; pyrifenox; pyriftalid; pyrimétaphos; pyrimethanil; pyrimicarbe; pyrimidifen; pyrimitate; pyriminobac; pyrimiphos-éthyl; pyrimiphos-méthyl; pyriproxyfen; pyrithiobac; pyroquilon; pyroxychlor; pyroxyfur; quassia; quinacetol; quinalphos; quinalphos-methyl; quinazamid; quinclorac; quinconazole; quinmerac; quinoclamine; quinomethionate; quinonamid; quinothion; quinoxyfen; quintiofos; quintozene; quizalofop; quizalofop-P; rabenzazole; rafoxanide; reglone; resmethrin; rhodethanil; rimsulfuron; rodéthanil; ronnel; rotenone; ryania; sabadilla; salicylanilide; schradan; sebuthylazine; secbumeton; selamectin; sesone; sethoxydim; sevin; siduron; silafluofen; silthiofam; silvex; simazine; simeconazole; simeton; simetryn; simetryne; SMA; sodium arsenite; sodium chlorate; sodium fluoride; sodium hexafluorosilicate; sodium orthophenylphenoxide; sodium pentachlorophenate; sodium pentachlorophenoxide; sodium o-phenylphenoxide; sodium polysulfide; sodium silicofluoride; disodium tetraborate; sodium thiocyanate; solan; sophamide; spinosad; spirodiclofen; spiroxamine; stirofos; streptomycin; sulcofuron; sulcotrione; sulfallate; sulfentrazone; sulfiram; sulfluramid; sulfometuron; sulfosulfuron; sulfotep; sulfotepp; sulfur; sulfuric acid; sulfuryl fluoride; sulglycapin; sulprofos; sultropen; swep; 2,4,5-T; tau-fluvalinate; tazimcarb; 2,4,5-TB; 2,3,6-TBA; TBTO; TBZ; TCA; TCBA; TCMTB; TCNB; TDE; tebuconazole; tebufenozide; tebufenpyrad; tebupirimfos; tebutam; tebuthiuron; tecloftalam; tecnazene; tecoram; tedion; teflubenzuron; tefluthrin; temephos; TEPP; tepraloxydim; terallethrin; terbacil; terbucarb; terbuchlor; terbufos; terbumeton; terbuthylazine; terbutol; terbutryn; terbutryne; terraclor; tetrachloroethane; tetrachlorvinphos; tetraconazole; tetradifon; tetradisul; tetrafluron; tetramethrin; tetranactin; tetrasul; thenylchlor; theta-cypermethrin; thiabendazole; thiacloprid; thiadiazine; thiadifluor; thiamethoxam; thiameturon; thiazafluron; thiazone; thiazopyr; thicrofos; thicyofen; thidiazimin; thidiazuron; thifensulfuron; thifluzamide; thiobencarb; thiocarboxime; thiochlorfenphim; thiochlorphenphime; thiocyclam; thiodan; thiodicarb; thiofanocarb; thiofanox; thiomersal; thiometon; thionazin; thiophanate; thiophanate-ethyl; thiophanate-methyl; thiophos; thioquinox; thiosultap; thiram; thiuram; thuringiensin; tiabendazole; tiocarbazil; tioclorim; tioxymid; TMTD; tolclofos-methyl; tolylfluanid; tolfenpyrad; tolylmercury acetate; toxaphene; 2,4,5-TP; 2,3,3-TPA; TPN; tralkoxydim; tralomethrin; d-trans-allethrin; transfluthrin; transpermethrin; tri-allate; triadimefon; triadimenol; triallate; triamiphos; triarathene; triarimol; triasulfuron; triazamate; triazbutil; triaziflam; triazophos; triazothion; triazoxide; tribenuron; tributyltin oxide; tricamba; trichlamide; trichlorfon; trichlormetaphos-3; trichloronat; trichloronate; trichlorphon; triclopyr; tricyclazole; tricyclohexyltin; hydroxide; tridemorph; tridiphane; trietazine; trifenofos; trifloxysulfuron; triflumizole; triflumuron; trifluralin; triflusulfuron; trifop; trifopsime; triforine; trimeturon; triphenyltin; triprene; tripropindan; tritac; triticonazole; tritosulfuron; uniconazole; uniconazole-P; validamycin; vamidothion; vaniliprole; vernolate; vinclozolin; XMC; xylachlor; xylenols; xylylcarb; zarilamid; zeta-cypermethrin; zinc naphthenate; zineb; zolaprofos; zoxamide trichlorophenate; 1,2-dichloropropane; 1,3-dichloropropene; 2-methoxyethylmercury chloride; 2-phenylphenol; 2,3,3-TPA; 2,3,6-TBA; 2,4-D; 2,4-DB; 2,4-DEB; 2,4-DEP; 2,4-DP; 2,4-MCPB; 2,4,5-T; 2,4,5-TB; 2,4,5-TP; 3,4-DA; 3,4-DB; 3,4-DP; 4-CPA; 4-CPB; 4-CPP; 8-hydroxyquinoline sulfate;
4-(3-trifluoromethylphenoxy)-2-(4-trifluoromethylphenyl)-pyrimidine and 3-heterocyclyl-substituted benzoyl derivatives of the formula IX 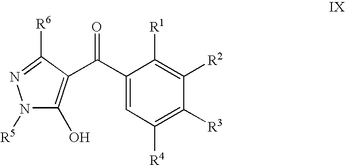
in which the variables R¹ to R⁶ have the following meanings:
R¹,R³ are hydrogen, halogen, C₁-C₆-alkyl, C₁-C₆-haloalkyl, C₁-C₆-alkoxy, C₁-C₆-haloalkoxy, C₁-C₆-alkylthio, C₁-C₆-alkylsulfinyl or C₁-C₆-alkylsulfonyl;
R² is a heterocyclic radical selected from the group consisting of thiazol-2-yl, thiazol-4-yl, thiazol-5-yl, isoxazol-3-yl, isoxazol-4-yl, isoxazol-5-yl, 4,5-dihydroisoxazol-3-yl, 4,5-dihydroisoxazol-4-yl and 4,5-dihydroisoxazol-5-yl, where the abovementioned nine radicals can optionally be monosubstituted or polysubstituted by halogen, C₁-C₄-alkyl, C₁-C₄-alkoxy, C₁-C₄-haloalkyl, C₁-C₄-haloalkoxy or C₁-C₄-alkylthio;
R⁴ is hydrogen, halogen or C₁-C₆-alkyl;
R⁵ is C₁-C₆-alkyl;
R⁶ is hydrogen or C₁-C₆-alkyl.

When used in crop protection, the application rates are between 0.01 and 2.0 kg of active ingredient per ha, depending on the climatic conditions and the nature of the phytotoxic agrochemical and the plant.

In the treatment of seed, the active ingredients are generally required in amounts of from 0.001 to 0.1 g, preferably 0.01 to 0.05 g, per kilogram of seed.

The compounds I can be converted into the formulations conventionally used for fungicides, for example solutions, emulsions, suspensions, dusts, powders, pastes and granules. The use form depends on the intended use; in any case, it should ensure that the compound according to the invention is distributed finely and evenly.

The formulations are prepared in the known manner, for example by extending the active ingredient with solvents and/or carriers, if desired using emulsifiers and dispersants, it also being possible to use other organic solvents as cosolvents if water is used as the diluent. Adjuvants are essentially those which are also conventionally used for fungicides. In general, the formulations comprise between 0.01 and 95% by weight, preferably between 0.1 and 90% by weight, of the active ingredient. The active ingredients are employed in a purity of from 90% to 100%, preferably 95% to 100%-(according to NMR spectrum).

Examples of formulations are known from the publications cited at the outset.

Aqueous use forms can conventionally be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of wetter, adhesive, dispersant or emulsifier. It is also possible to prepare concentrates composed of active ingredient, wetter, adhesive, dispersant or emulsifier and, if appropriate, solvent or oil, and these concentrates are suitable for dilution with water.

The active ingredient concentrations in the ready-to-use preparations can be varied within substantial ranges. In general, they are between 0.0001 and 10%, preferably between 0.01 and 1%.

The active ingredients can also be used successfully in the ultra-low-volume method (ULV), it being possible to apply formulations with over 95% by weight of active ingredient or even the active ingredient without additions.

Various types of oils, or herbicides, other fungicides, other pesticides, or bactericides may be added to the active ingredients, if appropriate also just prior to use (tank mix).

These agents can be admixed to the agents according to the invention in a weight ratio of 1:10 to 10:1.

The information regarding the use according to the invention of the active ingredients I can be printed on the packaging or be provided in product data sheets. This information can also be provided in the case of products which can be applied in combination with the active ingredients I.

Use examples for increasing the resistance of the plants to the phytotoxicity of agrochemicals.

The active ingredients were prepared separately or jointly as a 10% emulsion in a mixture of 85% by weight of cyclohexanone, 5% by weight of Nekanil® LN (Lutensol® AP6, wetter with emulsifying and dispersing action based on ethoxylated alkylphenols) and 10% by weight of Wettol® EM (nonionic emulsifier based on ethoxylated castor oil) and diluted with water to give the desired concentration.

### USE EXAMPLE 1

### Effect of Active Ingredients and their Combinations on Plant Growth

Rice cv. “Koshihikari” was sown in a seedbox and grown for 24 days under controlled warm and moist conditions in controlled-environment cabinets and in the greenhouse. Two days before the rice was transplanted into the field, each of the seedboxes was sprayed to runoff point with preparations of the active ingredient in the concentrations mentioned hereinbelow in the form of an aqueous suspension made with a stock solution consisting of 10% active ingredient, 85% cyclohexanone and 5% emulsifier. The seedboxes were subsequently cultured in the greenhouse for a further 2 days until the rice was manually transplanted into the field at a rate of 5 clumps per m².

Three weeks after the treatment, the plant height of the rice clumps was measured and compared with untreated rice plants. The extent of plant stunting is a measure for the plant-damaging effect of substances on the root system.

The “phytotoxic agrochemical” used in the present example was the active ingredient [5-chloro-6-(2,4,6-trifluorophenyl)-[1,2,4]triazolo[1,5-a]pyrimidin-7-yl]-((S)-2,2,2-trifluoro-1-methylethyl)amine, which is disclosed in WO-A 98/46608 (compound A).

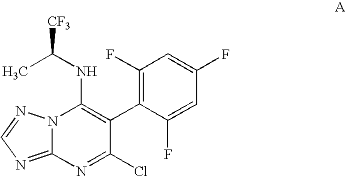

In this experiment, 15% stunting was observed in the rice plants treated with 200 g of active ingredient A per hectare, no dwarfing in the rice plants treated with 400 g of active ingredient I-16 per hectare, and 6% stunting in the rice plants treated with 600 g/ha active ingredient I-16. Only 6% dwarfing was observed in the plants treated with 200 g/ha active ingredient A and 600 g/ha active ingredient I-16, while only 3% dwarfing was observed in the plants treated with 200 g/ha active ingredient A and 400 g/ha active ingredient I-16.

### USE EXAMPLE 2

### Effect of Active Ingredients and their Combinations on the Herbicidal Activity

The “phytotoxic agrochemicals” used in this example were the active ingredients [3-(4,5-dihydroisoxazol-3-yl)-4-methane-sulfonyl-2-methylphenyl]-(5-hydroxy-1-methyl-1H-pyrazol-4-yl)-methanone (compound B) and 4-(3-trifluoromethylphenoxy)-2-(4-trifluoromethylphenyl)pyrimidine (compound C), which are disclosed in WO-A 98/31681 and EP-A 723 960, respectively:

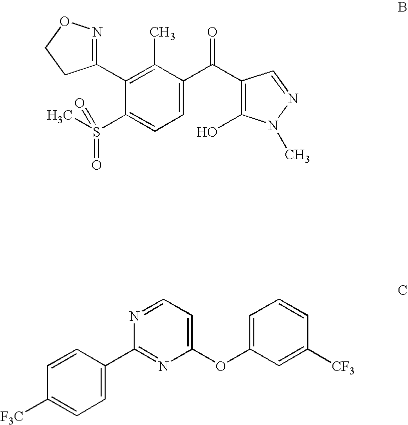

The safening effect of the compounds of the formula I on compounds B and C which were used as examples was demonstrated in the following experiment:

The culture containers used were plastic pots containing loamy sand with approximately 3.0% humus as substrate. The seeds of the test plants were sown separately for each species.

For the treatment, the test plants were first grown to a plant height of 3 to 15 cm, depending on their habit, and then treated with the active ingredients which were suspended or emulsified in water. The test plants were grown separately as seedlings and transplanted into the experimental containers a few days before the treatment.

Depending on the species, the plants were kept at temperatures of from 10 to 25° C. or 20 to 35° C. The experimental period extended over 2 to 4 weeks. During this time, the plants were tended, and their response to the individual treatments was evaluated.

The phytotoxicity was evaluated using a scale of from 0 to 100. In this context, 100 means complete destruction of at least the aerial parts, and 0 means no damage or normal course of growth.

The plants used in the greenhouse experiments were composed of the following species:

| Latin name | English name | Code |
|---|---|---|
| Oryza sativa | rice | ORYSA |
| Echinochloa | barnyardgrass | ECHCG |
| crus-galli | | |
| Triticum aestivum | spring wheat | TRZAS |
| Chenopodium album | pigweed | CHEAL |
| Pharbitis | morningglory | PHBPU |
| purpurea | | |

TABLE 2a
Herbicidal activity post-emergence

| Active | Application | Pytotoxicity | | |
|---|---|---|---|---|
| ingredient | rate [kg/ha] | ORYSA | ECHCG | PHBPU |
| B | 0.0039 | 20 | 90 | |
| II-5 + B | 0.125 + 0.0039 | 0 | 90 | |
| C | 0.0156 | 10 | | 98 |
| C | 0.0078 | 10 | | 98 |
| II-5 + C | 0.5 + 0.0156 | 0 | | 98 |
| II-5 + C | 0.25 + 0.0078 | 0 | | 98 |

TABLE 2b
Herbicidal activity post-emergence

| Active | Application | Pytotoxicity | | |
|---|---|---|---|---|
| ingredient | rate [kg/ha] | TRZAS | CHEAL | PHBPU |
| C | 0.0313 | 30 | 98 | |
| II-5 + C | 1.0 + 0.0313 | 15 | 98 | |
| C | 0.0156 | 25 | | 98 |
| C | 0.0078 | 20 | | 98 |
| II-5 + C | 0.5 + 0.0156 | 0 | | 98 |
| II-5 + C | 0.25 + 0.0078 | 0 | | 98 |

1. A method for increasing the resistance of plants to the phytotoxicity of other crop protection products, which comprises treating the plants, the soil or seeds with an effective amount of a compound of the formula I 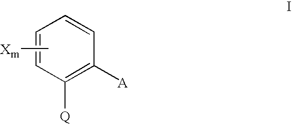
in which
X is halogen, C₁-C₄-alkyl or trifluoromethyl;
m is 0 or 1;
Q is C(═CH—CH₃)—COOCH₃, C(═CH—OCH₃)—COOCH₃, C(═N—OCH₃)—CONHCH₃, C(═N—OCH₃)—COOCH₃, N(—OCH₃)—COOCH₃ or a group Q1, 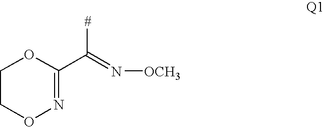
where # indicates the bond to the phenyl ring;
A is —O—B, —CH₂O—B, —OCH₂—B, —CH═CH—B, —C—C—B, —CH₂O—N═C(R¹)—B or —CH₂O—N═C(R¹)—C(R²)═N—OR³, where
B is phenyl, naphthyl, 5-membered or 6-membered hetaryl or 5-membered or 6-membered heterocyclyl comprising one to three N atoms and/or one O or S atom or one or two O and/or S atoms, the ring systems being unsubstituted or substituted by one to three radicals R^{a}:
R^{a} is cyano, nitro, amino, aminocarbonyl, aminothiocarbonyl, halogen, C₁-C₆-alkyl, C₁-C₆-haloalkyl, C₁-C₆-alkylcarbonyl, C₁-C₆-alkylsulfonyl, C₁-C₆-alkylsulfoxyl, C₃-C₆-cycloalkyl, C₁-C₆-alkoxy, C₁-C₆-haloalkoxy, C₁-C₆-alkyloxycarbonyl, C₁-C₆-alkylthio, C₁-C₆-alkylamino, di-C₁-C₆-alkylamino, C₁-C₆-alkylaminocarbonyl, di-C₁-C₆-alkylaminocarbonyl, C₁-C₆-alkylaminothiocarbonyl, di-C₁-C₆-alkylaminothiocarbonyl, C₂-C₆-alkenyl, C₂-C₆-alkenyloxy, phenyl, phenoxy, benzyl, benzyloxy, 5- or 6-membered heterocyclyl, 5- or 6-membered hetaryl, 5- or 6-membered hetaryloxy, C(═NOR′)—OR″ or OC(R′)₂—C(R″)═NOR″, the cyclic radicals, in turn, being unsubstituted or substituted by one to three radicals R^{b}:
R^{b} is cyano, nitro, halogen, amino, aminocarbonyl, aminothiocarbonyl, C₁-C₆-alkyl, C₁-C₆-haloalkyl, C₁-C₆-alkylsulfonyl, C₁-C₆-alkylsulfoxyl, C₃-C₆-cycloalkyl, C₁-C₆-alkoxy, C₁-C₆-haloalkoxy, C—C₆-alkoxycarbonyl, C₁-C₆-alkylthio, C₁-C₆-alkylamino, di-C₁-C₆-alkylamino, C₁-C₆-alkylaminocarbonyl, di-C₁-C₆-alkylaminocarbonyl, C₁-C₆-alkylaminothiocarbonyl, di-C₁-C₆-alkylaminothiocarbonyl, C₂-C₆-alkenyl, C₂-C₆-alkenyloxy, C₃-C₆-cycloalkyl, C₃-C₆-cycloalkenyl, phenyl, phenoxy, phenylthio, benzyl, benzyloxy, 5- or 6-membered heterocyclyl, 5- or 6-membered hetaryl, 5- or 6-membered hetaryloxy or C(═NOR′)—OR″;
R′ is hydrogen, cyano, C₁-C₆-alkyl, C₃-C₆-cycloalkyl or C₁-C₄-haloalkyl;
R″ is hydrogen, C₁-C₆-alkyl, C₃-C₆-alkenyl, C₃-C₆-alkynyl, C₁-C₄-haloalkyl, C₃-C₆-haloalkenyl or C₃-C₆-haloalkynyl;
R¹ is hydrogen, cyano, C₁-C₄-alkyl, C₁-C₄-haloalkyl, C₃-C₆-cycloalkyl, C₁-C₄-alkoxy;
R² is phenyl, phenylcarbonyl, phenylsulfonyl, 5- or 6-membered hetaryl, 5- or 6-membered hetarylcarbonyl or 5- or 6-membered hetarylsulfonyl, the ring systems being unsubstituted or substituted by one to three radicals R^{a},
C₁-C₁₀-alkyl, C₃-C₆-cycloalkyl, C₂-C₁₀-alkenyl, C₂-C₁₀-alkynyl, C₁-C₁₀-alkylcarbonyl, C₂-C₁₀-alkenylcarbonyl, C₃-C₁₀-alkynylcarbonyl, C₁-C₁₀-alkylsulfonyl or C(R′)═NOR″, the hydrocarbon radicals of these groups being unsubstituted or substituted by one to three radicals R^{c}:
R^{c} is cyano, nitro, amino, aminocarbonyl, aminothiocarbonyl, halogen, C₁-C₆-alkyl, C₁-C₆-haloalkyl, C₁-C₆-alkylsulfonyl, C₁-C₆-alkylsulfoxyl, C₁-C₆-alkoxy, C₁-C₆-haloalkoxy, C₁-C₆-alkoxycarbonyl, C₁-C₆-alkylthio, C₁-C₆-alkylamino, di-C₁-C₆-alkylamino, C₁-C₆-alkylaminocarbonyl, di-C₁-C₆-alkylaminocarbonyl, C₁-C₆-alkylaminothiocarbonyl, di-C₁-C₆-alkylaminothiocarbonyl, C₂-C₆-alkenyl, C₂-C₆-alkenyloxy,
C₃-C₆-cycloalkyl, C₃-C₆-cycloalkyloxy, 5- or 6-membered heterocyclyl, 5- or 6-membered heterocyclyloxy, benzyl, benzyloxy, phenyl, phenoxy, phenylthio, 5- or 6-membered hetaryl, 5- or 6-membered hetaryloxy and hetarylthio, it being possible for the cyclic groups, in turn, to be partially or fully halogenated or to have attached to them one to three radicals Ra; and
R³ is hydrogen,
C₁-C₆-alkyl, C₂-C₆-alkenyl, C₂-C₆-alkynyl, the hydrocarbon radicals of these groups being unsubstituted or substituted by one to three radicals R^{c};
which is taken up by the plants or seeds.

2. A method as claimed in claim 1 wherein, in formula I, the group Q is C(═CH—CH₃)—COOCH₃, C(═CH—OCH₃)—COOCH₃, C(═N—OCH₃)—CONHCH₃, C(═N—OCH₃)—COOCH₃ or N(—OCH₃)—COOCH₃.

3. A method as claimed in claim 1, wherein the index m is zero and the substituents in formula I have the following meanings:
A is —O—B, —CH₂O—B, —CH₂O—N═C(R¹)—B or CH₂—O—N═C(R¹)—C(R²)═N—OR³;
B is phenyl, pyridyl, pyrimidinyl, pyrazolyl, triazolyl, these ring systems being substituted by one or two radicals R^{a};
R¹ is hydrogen, cyano, cyclopropyl, C₁-C₄-alkyl or C₁-C₂-haloalkyl;
R² is C₁-C₄-alkyl, C₂-C₅-alkenyl, phenyl which is substituted by one or two halogen atoms, or is C(R′)═NOR″, where
R′ is one of the groups mentioned above under R¹ and
R″ is hydrogen, cyclopropyl or C₁-C₄-alkyl, and
R³ is one of the groups mentioned under R″.

4. A method as claimed in claim 1, wherein an active ingredient of the formula II 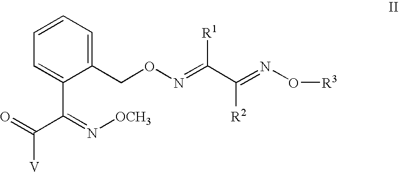
in which V is OCH₃ or NHCH₃ is used.

5. A method as claimed in claim 4, wherein an active ingredient of the formula II as claimed in claim 4 in which R² is C(R′)═NOR″ and R′ and R″ are each C₁-C₄-alkyl is used.

6. A method as claimed in claim 1, wherein an active ingredient of the formula III 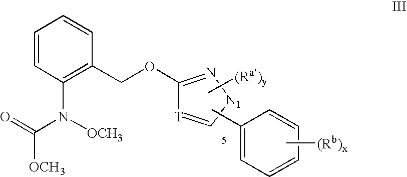
in which T is CH or N and R^{a}′ and R^{b} are halogen or C₁-C₄-alkyl, the phenyl group is in the 1- or 5-position and x is 0, 1 or 2 and y is 0 or 1 is used.

7. (canceled)
